(19) United States
(12) Patent Application Publication
(10) Pub. No.: US 2010/0180857 A1
(43) Pub. Date: Jul. 22, 2010

(54) PARTIALLY DEACTIVATABLE INTERNAL COMBUSTION ENGINE

(75) Inventors: Naoki YOKOYAMA, Wako-shi (JP); Kazushi TADA, Saitama (JP)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: HONDA MOTOR CO., LTD., Tokyo (JP)

(21) Appl. No.: 12/651,709

(22) Filed: Jan. 4, 2010

(30) Foreign Application Priority Data
Jan. 16, 2009 (JP) 2009-007720

(51) Int. Cl. F02D 17/02

(52) U.S. Cl. 123/198 F

(57) ABSTRACT

A partially deactivatable internal combustion engine has two cylinder banks 2R and 2L having cylinders. Some of the cylinders are deactivatable cylinders capable of deactivated by keeping engine valves for them closed and the rest are continuously working cylinders. A camshaft for a cylinder bank having the deactivatable cylinders drives an engine accessory, i.e. a fuel injection pump, whereby variation of camshaft driving torque can be suppressed.

### BACKGROUND OF THE INVENTION

1. Field of the Invention

The present invention relates to a partially deactivatable internal combustion engine having two cylinder banks, set at an angle to form a V or in a horizontally opposed arrangement, for example, and provided with cylinders including deactivatable cylinders and, more particularly, to an engine accessory arrangement in an engine valve operating mechanism of a partially deactivatable internal combustion engine having deactivatable cylinders.

2. Description of the Related Art

A V-type internal combustion engine is disclosed in JP 2007-224743 A, which has two cylinder banks set at an angle to form a V and provided with engine valve operating mechanism or valve trains interlocked with fuel injection pumps, respectively. This known V-type internal combustion engine has DOHC valve trains each including an intake camshaft extended on one side of the row of cylinders on the side of a space between the two cylinder banks and provided on one end thereof with a pump drive cam. Each fuel injection pump is disposed with a pump actuator thereof in contact with the pump drive cam.

The fuel injection pump is a high-pressure pump for supplying fuel to a fuel injection valve which injects fuel directly into each combustion chamber of the internal combustion engine. Therefore, a high pump driving torque needs to be applied to the intake camshaft provided with the pump drive cam.

If a phase at which the pump driving torque reaches a maximum coincides with a phase at which the valve driving torque applied to the intake camshaft reaches a maximum, camshaft driving torque for driving the intake camshaft varies in a wide range. Consequently, the tension of the timing belt for transmitting the rotation of the crankshaft to the intake camshaft varies in a wide range.

The internal combustion engine disclosed in JP 2007-224743 A is designed such that the phase at which the pump driving torque reaches a maximum does not coincide with the phase at which the camshaft driving torque needed to drive the intake camshaft reaches a maximum to suppress the variation of the camshaft driving torque.

The internal combustion engine mentioned in JP 2007-224743 A is an ordinary V-type internal combustion engine having cylinders that work continuously. Nothing about a partially deactivatable internal combustion engine having cylinders including a deactivatable cylinder is mentioned in JP 2007-224743 A.

### SUMMARY OF THE PRESENT INVENTION

The present invention has been made in view of the foregoing and it is therefore an object of the present invention to provide an engine accessory arrangement in a partially deactivatable internal combustion engine having cylinders arranged in two banks and including deactivatable cylinders, capable of suppressing variation of the camshaft driving torque needed to drive the camshafts of the engine.

To attain the above object, the present invention provides a partially deactivatable internal combustion engine comprising: two cylinder banks each having cylinders; engine valves provided for each of the cylinders; camshafts provided in each of the cylinder banks to open and close the engine valves for the cylinders; the cylinders including continuously working cylinders and deactivatable cylinders which are deactivated by keeping the engine valves therefor closed; and an engine accessory; wherein the engine accessory is configured to be driven for operation by a camshaft in a cylinder bank having a deactivatable cylinder.

In the partially deactivatable internal combustion engine according to the present invention, the engine accessory is driven for operation by the camshaft in the cylinder bank having the cylinders including the deactivatable cylinder. Therefore, the maximum of a composite driving torque can be reduced by effectively adding an accessory driving torque needed by the camshaft in the cylinder bank having the deactivatable cylinder to drive the engine accessory to the valve driving torque of the camshafts of the cylinder bank having only the continuously working cylinders needed to drive the engine valves.

In a preferred form of the present invention, both the cylinder banks have deactivatable cylinders, respectively, and the camshaft for driving the engine accessory is provided in each of the cylinder banks.

In this case, both the cylinder banks have the deactivatable cylinders, respectively, and the respective camshafts of the cylinder banks drive the engine accessories, respectively. Therefore, two accessories each capable of being driven by an accessory driving torque lower than that needed to drive the accessory driven only by the cam shaft of one of the two cylinder banks can be used in combination with the two cylinder banks, respectively. Thus, the maximum of a composite driving torque consisting of the valve driving torque and the accessory driving torque can be reduced, and load on an engine valve drive power transmitting member can be reduced by suppressing the variation of the driving torque.

In another preferred form of the present invention, all the cylinders of one of the cylinder banks are continuously working cylinders, all the cylinders of the other cylinder bank include a deactivatable cylinder, and the engine accessory is driven for operation by the camshaft of the other cylinder bank.

In this case, all the cylinders of the first one of the two cylinder banks are continuously working cylinders, the cylinders of the second one of the two cylinder banks includes a deactivatable cylinder, and the camshaft in the second cylinder bank is coupled with the engine accessory. Therefore, the maximum of the composite torque can be reduced by effectively adding the engine accessory driving torque of the camshaft of the second cylinder bank to the engine valve driving torque of the camshafts of the second cylinder bank, and load on the engine valve driving power transmitting member can be reduced by suppressing the variation of the driving torque.

The partially deactivatable internal combustion engine in a typical form of the present invention comprises a fuel injection valve for directly injecting fuel into each of the cylinders; wherein the engine accessory is a fuel injection pump, the camshaft for driving the engine accessory has a pump drive cam formed on the camshaft, and the fuel injection pump has a pump actuator driven by the pump drive cam on the camshaft to supply fuel under pressure to the fuel injection valve.

In this case, the partially deactivatable internal combustion engine includes the fuel injection valves respectively for directly injecting fuel into the combustion chambers, and the engine accessory is the fuel injection pump driven by the actuator driven by the pump drive cam formed on the camshaft to supply fuel under pressure to the fuel injection valves. The camshaft needs a comparatively high pump driving torque to drive the fuel injection pump to supply fuel under high pressure to the fuel injection valves which are required to inject fuel under high pressure in a direct injection mode. Thus, the variation of the driving torque can be suppressed by effectively reducing the maximum of the composite driving torque consisting of the valve driving torque and the accessory driving torque.

In a preferred form of the present invention, the camshafts have valve drive cams for opening and closing the engine valves, respectively, and the pump drive cam is configured to have such an operational phase relative to those of the valve drive cams for driving the engine valves that a phase at which a valve driving torque needed by the camshafts reaches a maximum or a minimum does not coincide with a phase at which a pump driving torque needed by the camshaft provided with the pump drive cam reaches a maximum or a minimum, while the partially deactivatable internal combustion engine is operating in a partially deactivated mode in which the deactivatable cylinders are deactivated.

In this case, the phase of the pump drive cam relative to those of the valve drive cams for driving the intake and the exhaust valves is determined such that a phase at which the valve driving torque needed by the camshafts reaches a maximum or a minimum does not coincide with a phase at which the pump driving torque needed by the camshaft provided with the pump drive cam reaches a maximum or a minimum, while the partially deactivatable internal combustion engine is operating in a partially deactivated mode in which the deactivatable cylinder is deactivated. Therefore, the maximum of the composite driving torque consisting of the valve driving torque and the pump driving torque can be limited to a low value and the variation of the driving torque can be suppressed.

In a further preferred form of the present invention, the phase of the pump drive cam relative to those of the valve drive cams for driving the engine valves is determined such that the phase at which the valve driving torque of the camshafts reaches a maximum or a minimum substantially coincides with the phase at which the pump driving torque needed by the camshaft having the pump drive cam reaches a minimum or a maximum, while the partially deactivatable internal combustion engine is operating in a partially deactivated mode in which the deactivatable cylinders are deactivated.

The phase of the pump drive cam relative to those of the valve drive cams for driving the engine valves is determined such that a phase at which the valve driving torque needed by the camshafts reaches a maximum or a minimum substantially coincides with a phase at which the pump driving torque needed by the camshaft provided with the pump driving cam reaches a minimum or a maximum, while the partially deactivatable internal combustion engine is operating in a partially deactivated mode in which the deactivatable cylinder is deactivated. Therefore, the maximum of the composite driving torque consisting of the valve driving torque and the pump driving torque can be reduced to the lowest possible value and the variation of the driving torque can be suppressed.

### BRIEF DESCRIPTION OF THE DRAWINGS

FIG. 1 is a front end view of a part of a water-cooled four-stroke V-8 internal combustion engine in a first embodiment of the present invention;

FIG. 2 is a plan view of the internal combustion engine shown in FIG. 1;

FIG. 3 is a plan view of a valve train including intake camshafts and exhaust camshafts of the internal combustion engine shown in FIG. 1;

FIG. 4 is a perspective view of an intake camshaft and an exhaust camshaft included in a valve train for a right cylinder bank, second and fourth cylinders of the right cylinder bank, and intake and exhaust valve operating mechanisms for the second and fourth cylinders of the right cylinder bank of the engine shown in FIG. 1;

FIG. 5 is a perspective view of an intake camshaft and an exhaust camshaft included in a valve train for the left cylinder bank, the second and the fourth cylinder of the left cylinder bank, and an intake and an exhaust valve operating mechanism for the second and the fourth cylinder of the left cylinder bank of the internal combustion engine shown in FIG. 1;

FIG. 6 is a sectional development of an intake valve driving mechanism for a continuously working cylinder;

FIG. 7 is a sectional development of an intake valve driving mechanism with a deactivation mechanism for a deactivatable cylinder;

FIG. 8 is a diagram showing variation of torques applied to the intake and exhaust camshafts of the right cylinder bank, with crank angle in a partially deactivated state;

FIG. 9 is a diagram showing variation of torques applied to the intake and exhaust camshafts of the left cylinder bank, with crank angle in a partially deactivated state;

FIG. 10 is a diagram showing variation of a composite torque consisting of torques needed by the respective intake and exhaust camshafts of the right and left banks, with crank angle in a partially deactivated state;

FIG. 11 is a front end view of a part of a water-cooled four-stroke V-6 internal combustion engine in a second embodiment of the present invention;

FIG. 12 is a plan view of the internal combustion engine shown in FIG. 11;

FIG. 13 is a plan view of a valve train including intake camshafts and exhaust camshafts included in the internal combustion engine shown in FIG. 12; and

FIG. 14 is a diagram showing variation of a composite torque consisting of torques applied to the respective intake and exhaust camshafts of the right and left banks, with crank angle in a partially deactivated state.

### DESCRIPTION OF THE PREFERRED EMBODIMENTS

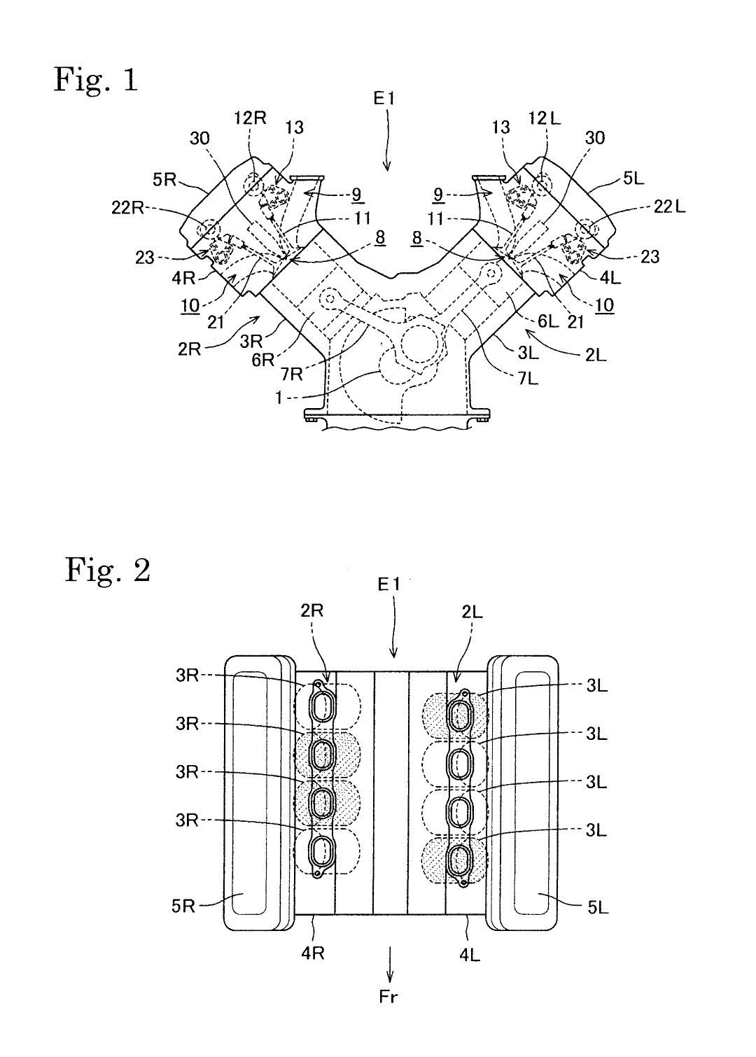

A partially deactivatable internal combustion engine E1 in a first embodiment of the present invention will be described with reference to FIGS. 1 to 10.

As shown in FIG. 1, the partially deactivatable internal combustion engine E1 is a water-cooled V-8 automotive internal combustion engine. The V-8 internal combustion engine E1 is mounted on a vehicle with a crankshaft 1 thereof extending parallel to the longitudinal axis of the body of the vehicle. The V-8 internal combustion engine E1 has a right cylinder bank 2R and a left cylinder bank 2L set at an angle to form a V.

Referring to FIG. 2, the right cylinder bank 2R and the left cylinder bank 2L have four cylinders 3R and four cylinders 4L, respectively. The four cylinders 3R are arranged in a row and the four cylinders 3L are arranged in a row. The left cylinder bank 2L is displaced slightly forward relative to the right cylinder bank 2R. FIG. 1 is a front end view. The right and left sides indicated in FIGS. 1 and 2 are opposite to the right and left sides of the vehicle body, respectively.

Cylinder heads 4R and 4L are put on and fastened to the right cylinders 3R and the left cylinders 3L, respectively. The cylinder heads 4R and 4L are covered with head covers 5R and 5L. The right cylinder bank 2R including the cylinders 3R, the cylinder head 4R and the head cover 5R, and the left cylinder bank 3L including the cylinders 3L, the cylinder head 4L and the head cover 5L are set at an angle to form a V.

Pistons 6R and 6L are axially slidably fitted in the cylinder bores of the cylinders 3R and 3L, respectively. The pistons 6R and 6L are connected to the crankshaft 1 by connecting rods 7R and 7L, respectively, to form a piston-crank mechanism. Combustion chambers 8 are formed by the top surfaces of the pistons 6R and 6L and the cylinder heads 4R and 4L, respectively. Intake ports 9 opening into the combustion chambers 8 extend inward, i.e., toward the space between the right cylinder bank 2R and the left cylinder bank 2L, on the inner side of the right cylinder bank 2R and the left cylinder bank 2L. Exhaust ports 10 extend outward, i.e., away from the space between the right cylinder bank 2R and the left cylinder bank 2L, on the outer side of the right cylinder bank 2R and the left cylinder bank 2L.

An intake camshaft 12R and an exhaust camshaft 22R, namely, valve drive camshafts, extend parallel to the crankshaft 1 on the cylinder head 4R, and an intake camshaft 12L and an exhaust camshaft 22L, namely, valve drive camshafts, extend parallel to the crankshaft 1 on the cylinder head 4L to form DOHC valve trains, respectively. The intake camshafts 12R and 12L are on the inner sides of the cylinder banks 2R and 2L, respectively. The exhaust camshafts 22R and 22L are on the outer sides of the cylinder banks 2R and 2L, respectively.

Engine valves or intake valves 11 for opening and closing intake ports 9 opening into the combustion chambers 8 and the intake camshaft 12R (12L) are interlocked by an intake valve drive mechanism 13 for converting the rotation of the intake camshaft 12R (12L) into axial motion of the intake valves 11. Engine valves or exhaust valves 21 for opening and closing exhaust ports 10 opening into the combustion chambers 8 and the exhaust camshaft 22R (22L) are interlocked by an exhaust valve drive mechanism 23 for converting the rotation of the exhaust camshaft 22R (22L) into axial motion of the exhaust valves 21.

The intake valve drive mechanisms 13 and the exhaust valve drive mechanisms 23 are provided with a valve lift changing mechanism for changing valve lift according to operating conditions of the V-8 internal combustion engine E1. Some of the intake valve drive mechanisms 13 and the exhaust valve drive mechanisms 23 are provided with a deactivating mechanisms for keeping the intake valves 11 and the exhaust valves 21 closed to deactivate the corresponding cylinders 3R (3L) and other intake valve drive mechanisms 13 and other exhaust valve drive mechanisms 23 are not provided with any deactivating mechanism.

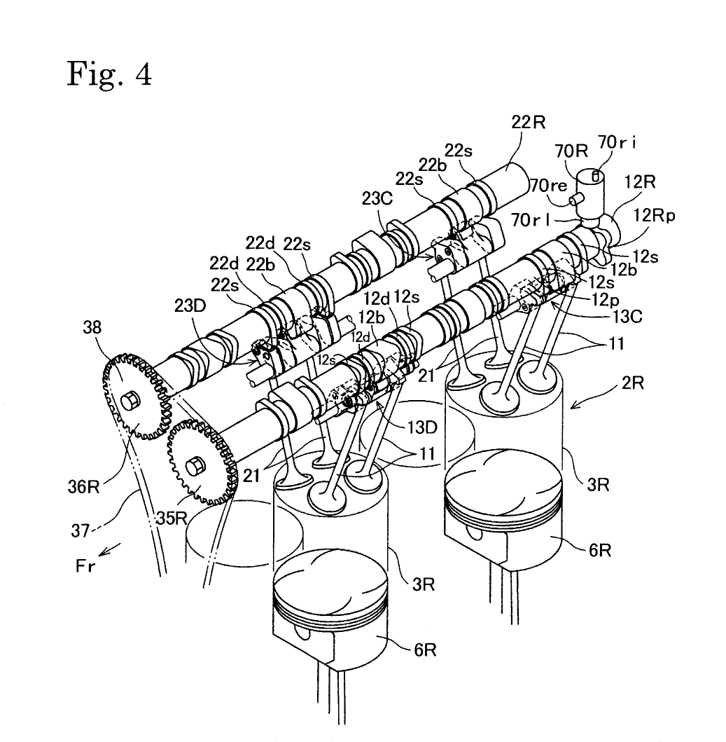

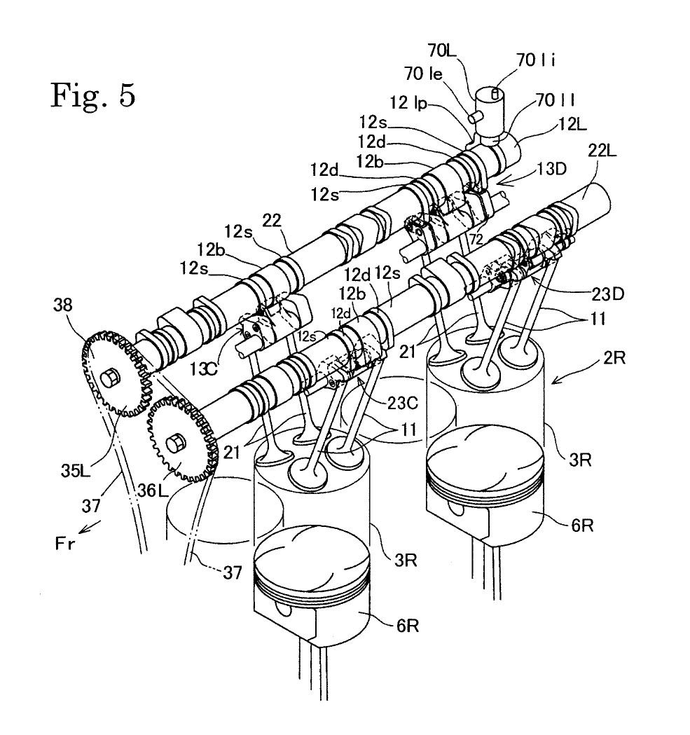

Referring to FIGS. 4 and 5, the deactivating intake valve drive mechanisms, namely, the intake valve drive mechanisms with the deactivating mechanism, among the intake valve drive mechanisms 13 are designated by 13D, and the deactivating exhaust valve drive mechanisms, namely, the exhaust valve drive mechanisms with the deactivating mechanism, among the exhaust valve drive mechanisms 23 are designated by 23D. The continuously working intake valve drive mechanisms, namely, the exhaust valve drive mechanism not provided with the deactivating mechanism, are designated by 13C, and the continuously working exhaust valve drive mechanisms, namely, the exhaust valve drive mechanisms not provided with the deactivating mechanism, are designated by 23C. The cylinders each provided with the deactivating intake valve drive mechanism 13D and the deactivating exhaust valve drive mechanism 23D are deactivatable cylinders. The cylinders each provided with the continuously working intake valve drive mechanism 13C and the continuously working exhaust valve drive mechanism 23C are continuously working cylinders.

The four cylinders among the eight cylinders of the V-8 internal combustion engine E1 are deactivatable cylinders provided with the intake valves 11 and the exhaust valves 21 that can be kept closed to deactivate the deactivatable cylinders. In FIG. 2, the two inner cylinders, namely, the second and third cylinders, of the right cylinder bank 2R and the two outer cylinders, namely, the first and fourth cylinders, of the left cylinder bank 2L are deactivatable cylinders. The rest of the cylinders are continuously working cylinders. In FIG. 2, the deactivatable cylinders are shaded with crossing oblique broken lines.

The V-8 internal combustion engine E1 is provided with fuel injection valves 30 for injecting fuel directly into the combustion chambers 8. The fuel injection valves 30 are inserted into bores formed in parts of the cylinder heads 4R and 4L corresponding to the centers of the tops of the combustion chambers 8 and opening into the combustion chambers 8, respectively. Spark plugs, not shown, are inserted into bores formed in the cylinder heads 4R and 4L so as to face the combustion chambers 8, respectively.

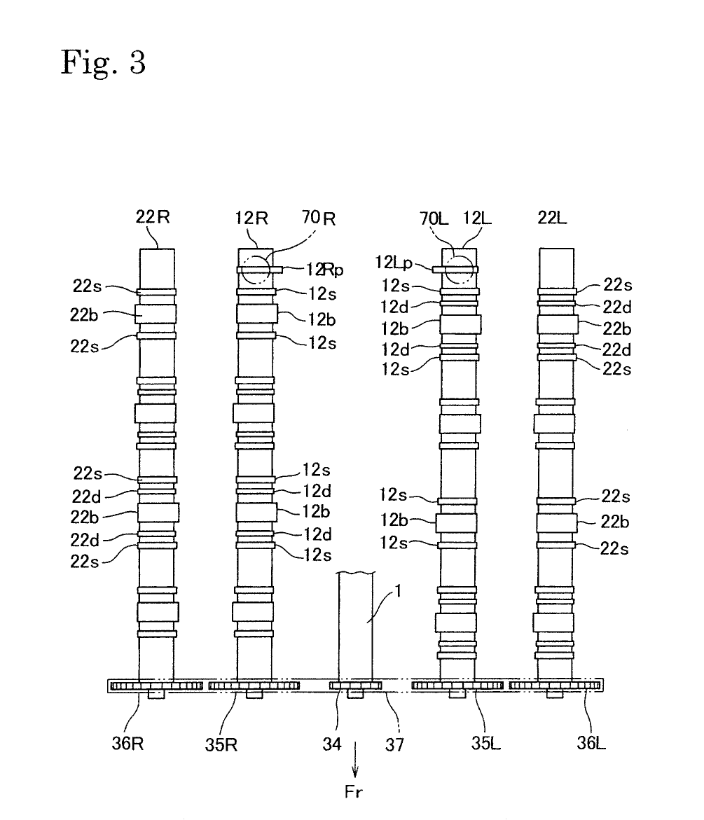

FIG. 3 shows the arrangement of the intake camshafts 12R and 12L and the exhaust camshafts 22R and 22L of the valve trans. As shown, driven pulleys 35R and 35L are mounted on the front ends of the intake camshaft 12R and 12L, respectively, and driven pulleys 36R and 36L are mounted on front ends of the exhaust camshafts 22R and 22L, respectively.

An endless timing belt 37, namely, a valve drive power transmitting member, is wound round a drive pulley 34 mounted on the crankshaft 1 and the driven pulleys 35R, 35L, 36R and 36L to transmit the rotation of the crankshaft 1 to the intake camshafts 12R and 12L and the exhaust camshafts 22R and 22L. The intake camshafts 12R and 12L and the exhaust camshafts 22R and 22L rotate at half the rotational speed of the crankshaft 1.

FIG. 4 shows a perspective view of the intake camshaft 12R and the exhaust camshaft 22R of the right cylinder bank 2R, the second and fourth cylinders 3R of the right cylinder bank 2R, valve operating mechanisms 13 and the exhaust valve operating mechanism 13 for the second and fourth cylinders 3R of the right cylinder bank 2R.

In the right cylinder bank 2R, the two inner cylinders, namely, the second and third cylinders, are deactivatable cylinders and the two outer cylinders, namely, the first and fourth cylinders, are continuously working cylinders. Therefore, the second cylinder, namely, the deactivatable cylinder, is provided with the deactivating intake valve drive mechanism 13D and the deactivating exhaust valve drive mechanism 23D, while the fourth cylinder, namely, the continuously working cylinder, is provided with the continuously working intake valve drive mechanisms 13C and the continuously working exhaust valve drive mechanism 23C.

FIG. 5 shows a perspective view of the intake camshaft 12L and the exhaust camshaft 12L included in the valve train for the left cylinder bank 2L, the second and fourth cylinders 3L of the left cylinder bank 2L, and the intake and exhaust valve operating mechanisms for the second and the fourth cylinder 3L of the left cylinder bank 2L.

In the left cylinder bank 2L, the two outer cylinders, namely, the first and fourth cylinders, are deactivatable cylinders and the two inner cylinders, namely, the second and third cylinders, are continuously working cylinders. Therefore, the second cylinder, namely, the continuously working cylinder, is provided with the continuously working intake valve drive mechanisms 13C and the continuously working exhaust valve drive mechanism 23C, while the fourth cylinder, namely, the deactivatable cylinder, is provided with the deactivating intake valve drive mechanism 13D and the deactivating exhaust valve drive mechanism 23D.

Referring to FIG. 3, parts of the intake camshafts 12R and 12L corresponding to the continuously working cylinders are provided at their middle parts with high-lobe intake cams 12b having a high lobe, respectively. Low-lobe intake cams 12s are formed adjacent to each high-lobe intake cam 12b on both sides of each high-lobe intake cam 12b.

Similarly, parts of the exhaust cam shafts 22R and 22L corresponding to the continuously working cylinders are provided at their middle parts with high-lobe exhaust cams 22b having a high lobe, respectively. Low-lobe exhaust cams 22s having a low lobe are formed adjacent to each high-lobe exhaust cam 22b on both sides of the high-lobe exhaust cam 22b.

Parts of the intake camshafts 12R and 12L corresponding to the deactivatable cylinders are provided at their middle parts with high-lobe intake cams 12b, respectively. Round deactivating cams 22d of a diameter equal to that of the base circle of the high-lobe intake cam 12b are formed adjacent to each high-lobe intake cam 12b on both sides of the high-lobe intake cam 12b. Low-lobe intake cams 12s are formed on the outer side of the deactivating cams 12d, respectively.

Parts of the exhaust camshafts 22R and 22L corresponding to the deactivatable cylinders are provided at their middle parts with high-lobe exhaust cams 22b, respectively. Round deactivating cams 22d of a diameter equal to that of the base circle of the high-lobe exhaust cam 22b are formed adjacent to each high-lobe exhaust cam 22b on both sides of the high-lobe exhaust cam 22b. The low-lobe exhaust cams 22s are formed on the outer sides of the deactivating cams 22d, respectively.

The intake camshafts 12R and 12L are provided in parts near the rear ends thereof with pump drive cams 12Rp and 12Lp, respectively. Fuel injection pumps 70R and 70L as engine accessories are disposed above the pump drive cams 12Rp and 12Lp, respectively. Actuators 70rl and 70ll included in the fuel injection pumps 70R and 70L are in contact with the pump drive cams 12Rp and 12Lp, respectively. The pump drive cams 12Rp and 12Lp drive the fuel injection pumps 70R and 70L, respectively.

Each of the pump drive cams 12Rp and 12Lp has two diametrically opposite cam toes of a circular arc forming a central angle of 180°. The intake camshafts 12R and 12L make one full turn while the crankshaft 1 makes two full turns. Therefore, the pump drive cams 12Rp and 12Lp cause the actuators 70rl and 70ll to make reciprocation twice while the crankshaft 1 makes two full turns.

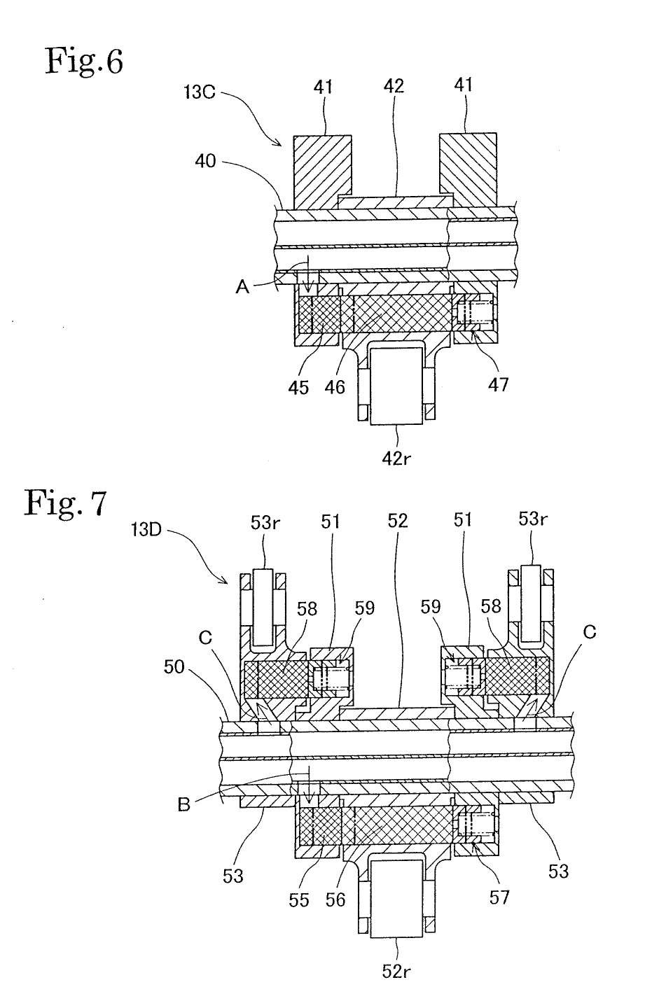

The continuously working intake valve drive mechanisms 13C and the continuously working exhaust valve drive mechanisms 23C are the same in construction. The continuously working intake valve drive mechanism 13C will be described briefly in connection with a sectional development thereof shown in FIG. 6. Rocker arms 41 engaged with the pair of intake valves 11 for the continuously working cylinder are supported for rocking on a rocker arm shaft 40. A free rocker arm 42 is disposed between the rocker arms 41 and is supported for rocking on the rocker arm shaft 40.

The rocker arms 41 are engaged directly with the low-lobe intake cams 12s on the intake camshafts 12R and 12L. A roller 42r supported on the cam end of the free rocker arm 42 is in contact with the high-lobe intake cam 12b on the intake camshaft 12.

The rocker arm 41, the free rocker arm 42 and the rocker arm 41 are arranged in this order. The rocker arms 41 and the free rocker arm 42 are provided with bores that are aligned in a valve-closing state. Selector pistons 45 and 46 are inserted into the bores and are pressed by a pressing device 47.

The selector pistons 45 and 46 move against the bias of the pressing device 47 when oil pressure is applied in the direction of the arrow A in FIG. 6 through the interior of the rocker arm shaft 40 to the selector piston 45 in the bore.

In a state where no oil pressure is applied to the selector piston 45, the selector pistons 45 and 46 and the pressing device 47 stay in the bores of the rocker arm 41, the free rocker arm 42 and the rocker arm 41, respectively, and the rocker arm 41, the free rocker arm 42 and the rocker arm 41 are disconnected from each other and can rock individually. Consequently, the cam motion of the low-lobe intake cams 12s is transferred effectively to the rocker arms 41 to rock the same, so that the intake valves 11 are opened and closed with a low valve lift for operation in a low-intake-rate operating mode.

When oil pressure is applied to the selector piston 45, the selector piston 45 extends over the rocker arm 41 and the free rocker arm 42, and the selector piston 46 extends over the free rocker arm 42 and the rocker arm 41. Therefore, the rocker arm 41, the free rocker arm 42 and the rocker arm 41 are interlocked for rocking in a unit. Consequently, the cam motion of the high-lobe intake cam 12b is transferred effectively through the free rocker arm 42 to the rocker arms 41 to open and close the intake valves 11 with a great lift for operation in a high-intake-rate operating mode.

The continuously working intake valve drive mechanism 13C for the continuously working cylinder can be selectively switched over between a low-intake-rate operating mode and a high-intake-rate operating mode by hydraulic control. The continuously working exhaust valve drive mechanism 23C is the same in construction as the continuously working intake valve drive mechanism 13C, and hence the description thereof will be dispensed with.

The deactivating intake valve drive mechanism 13D will be described briefly in connection with a sectional development thereof shown in FIG. 7. Rocker arms 51 engaged with the pair of intake valves 11 for the deactivatable cylinder are supported for rocking on a rocker arm shaft 50. A first free rocker arm 52 is disposed between the rocker arms 51 and supported on the rocker arm shaft 50 for rocking. Second free rocker arms 53 are disposed adjacent to the rocker arms 51 on the outer sides of the rocker arms 51 and are supported for rocking on the rocker arm shaft 50.

The rocker arms 51 are engaged directly with the deactivating cams 12d on the intake camshafts 12R and 12L. A roller 52r supported on the cam end of the first free rocker arm 52 is in contact with the high-lobe intake cams 12b formed on the intake camshaft 12. Rollers 53r supported on the cam ends of the second free rocker arms 53 are in contact with the low-lobe intake cams 12s formed on the intake camshaft 12

The middle first free rocker arm 52 and the rocker arms 51 on the opposite sides of the first free rocker arm 52 are provided with bores that are aligned in a valve-closing state. Selector pistons 55 and 56 are inserted into the bores and are biased by a pressing device 57. The selector pistons 55 and 56 move against the bias of the pressing device 57 when oil pressure is applied in the direction of the arrow B in FIG. 7 through the interior of the rocker arm shaft 50 to the selector piston 55 in the bore.

In a state where no oil pressure is applied to the selector piston 55, the selector pistons 55 and 56 and the pressing device 57 stay in the bores of the rocker arm 51, the first free rocker arm 52 and the rocker arm 51, respectively, and the rocker arm 51, the first free rocker arm 52 and the rocker arm 51 are disconnected from each other and can rock individually. When oil pressure is applied to the selector piston 55, the selector piston 55 extends over the rocker arm 51 and the first free rocker arm 52, and the selector piston 56 extends over the first free rocker arm 52 and the rocker arm 51. Therefore, the rocker arm 51, the first free rocker arm 52 and the rocker arm 51 are interlocked for rocking in a unit.

The rocker arms 51 and the second free rocker arms 53 respectively on the outer sides of the rocker arms 51 are provided with bores that are aligned in a valve-closing state. Selector pistons 58 are inserted into the bores and are pressed by pressing devices 59, respectively.

The selector pistons 58 move against the bias of the pressing devices 59 when oil pressure is applied in the direction of the arrow C in FIG. 7 through the interior of the rocker arm shaft 50 to the selector pistons 58 inserted in the bore.

In a state where no oil pressure is applied to the selector pistons 58, the selector pistons 58 and the pressing devices 59 stay in the bores of the rocker arms 51 and the second free rocker arms 53, respectively, and the rocker arms 51 and the second free rocker arms 53 are disconnected from each other and can rock individually. When oil pressure is applied to the selector pistons 58, each of the selector pins 58 extends over the rocker arm 51 and the second free rocker arm 53. Consequently, the rocker arms 51 and the second free rocker arms 53 are interlocked and rock in a unit.

When no oil pressure is applied to the selector piston 55 and the selector pistons 58, the first free rocker arm 52, the rocker arms 51 and the second free rocker arms 53 rock individually. Therefore, the rocker arms 51 in contact with the deactivating cams 12d not having any cam lobe do not rock and, consequently, the intake valves 11 remain closed to deactivate the cylinder.

When oil pressure is applied to the selector pistons 58 in this state, the selector piston 58 interlocks the rocker arms 51 and the second free rocker arms 53. Consequently, the respective cam motions of the low-lobe intake cams 12s are transferred effectively through the second free rocker arms 53 to the rocker arms 51 to open and close the intake valves 11 with a small lift for operation in a low-intake-rate operating mode.

When oil pressure is applied to the selector piston 55 in a state where the cylinder is deactivated, the selector pistons 58 interlock the rocker arms 51 and the second free rocker arms 52. Consequently, the cam motion of the high-lobe intake cam 12b is transferred effectively through the first free rocker arm 52 to the rocker arms 51 to rock the rocker arms 52. Consequently, the intake valves are opened and closed with a great lift for operation in a high-intake-rate operating mode.

The deactivatable cylinder can be selectively set in a deactivated state, a low-intake-rate working state or a high-intake-rate working state by controlling oil pressure applied to the deactivating intake valve drive mechanism 13D for the deactivatable cylinder. The deactivating exhaust valve drive mechanism 23D is the same in construction as the deactivating intake valve drive mechanism 13D, and hence the description thereof will be dispensed with.

When a deactivation signal is provided while the V-8 internal combustion engine E1 is in operation, the first free rocker arm 52, the rocker arms 51 and the second free rocker arms 53 for each of the four deactivatable cylinders, namely, the second and third deactivatable cylinders of the right cylinder bank 2R and the first and fourth deactivatable cylinders of the left cylinder bank 2L, are disconnected from each other and rock individually. Consequently, the V8 internal combustion engine E1 is set in a partially deactivated state in which the intake valves 11 and the exhaust valves 21 remain closed, and the other four cylinders, namely, the continuously working cylinders, operate.

While the V-8 internal combustion engine E1 is operating at low engine speed under a low load, the free rocker arm 42 and the rocker arms 41 for each of the continuously working cylinders are disconnected from each other, while in each of the deactivatable cylinders the rocker arms 51 and the second free rocker arms 53 are interlocked, and the first rocker arm 52 and the rocker arms 51 for each of the deactivatable cylinders are disconnected from each other to operate the engine E1 in a low-intake-rate operating mode.

While the V-8 internal combustion engine E1 is operating at high engine speed under a high load, the free rocker arm 12 and the rocker arms 41 for each of the continuously working cylinders are interlocked, the high-lobe intake cams 12b work, while the rocker arms 51 and the first rocker arms 53 for each of the deactivatable cylinders are disconnected from each other, and the first rocker arm 52 and the rocker arms 51 for each of the deactivatable cylinders are interlocked and the high-lobe intake cams 12b work. Thus, the engine E1 operates in a high-intake-rate operating mode.

Both the right cylinder bank 2R and the left cylinder bank 2L set at an angle to form a V and respectively provided with the DOHC valve trains have the deactivatable cylinders. The pump drive cams 12Rp and 12Lp formed on the respective intake camshafts 12R and 12L of the right cylinder bank 2R and the left cylinder bank 2L drive the fuel injection pumps 70R and 70L, respectively.

The fuel injection pumps 70R and 70L are plunger pumps provided with plungers formed integrally with the actuators and capable of reciprocating in pump bodies, respectively. The fuel injection pumps 70R and 70L suck fuel supplied under pressure from a fuel tank, not shown, by a fuel pump, not shown, through suction ports 70ri and 70li in pressurizing chambers of the pump body and discharge the pressurized fuel through discharge ports 70re and 70le into fuel distribution lines.

The fuel injection pumps 70R and 70L are provided with built-in spill valves, not shown, respectively. The pressure of fuel in the fuel distribution lines can be regulated by controlling the opening and closing operation of the spill valves to regulate the quantity of fuel discharged through the discharge ports 70re and 70le (fuel spill control).

Fuel of a high pressure regulated by fuel spill control is supplied through the fuel distribution lines connected to the discharge ports 70re and 70le to the fuel injection valves 30 that inject fuel directly into the combustion chambers 8 of the four cylinders of the right cylinder bank 2R and into the combustion chambers 8 of the four cylinders of the left cylinder bank 2L. Thus, injection pressure for delivering fuel by the fuel injection valves 30 to the cylinders is controlled through fuel spill control.

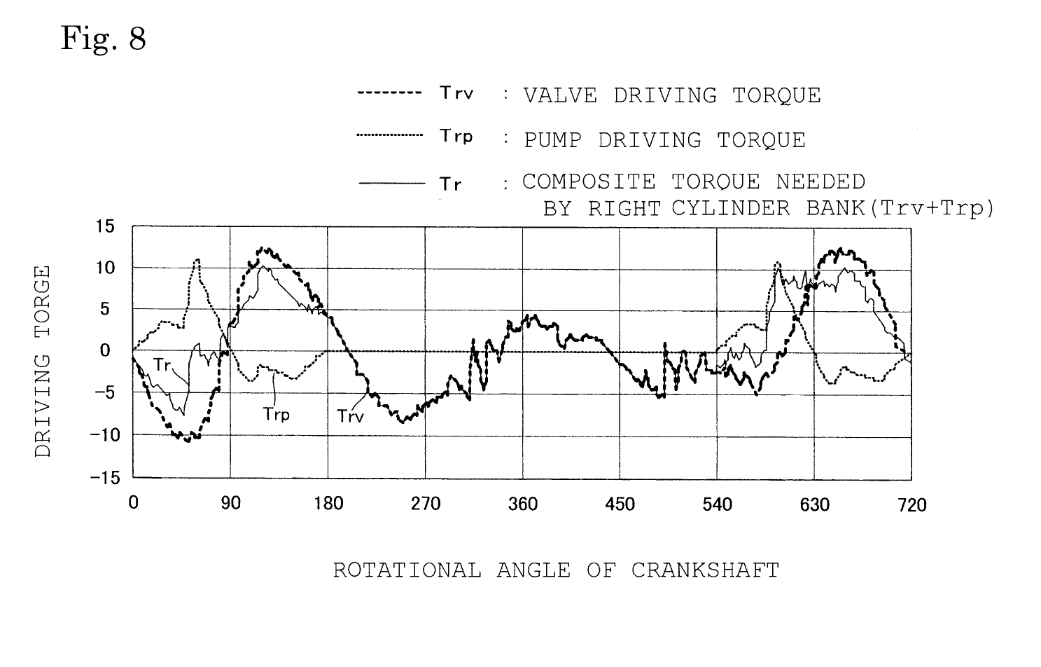

FIG. 8 is a diagram showing the variation of torques respectively needed by the intake camshaft 12R and the exhaust camshaft 22R for the right cylinder bank 2R with crank angle while the V-8 internal combustion engine E1 is in a partially deactivated state. Since the intake camshaft 12R and the exhaust camshaft 22R make one full turn while the crankshaft 1 makes two full turns, one operation cycle of the intake camshaft 12R and the exhaust camshaft 22R is completed while the crankshaft 1 turns through 720°.

In FIG. 8, valve driving torque Trv is indicated by a thick broken curve, pump driving torque Trp needed by the intake camshaft 12R to drive the fuel injection pump 70R by the pump drive cam 12Rp is indicated by a dotted curve, and right cylinder bank driving torque Tr is indicated by continuous curve. The valve driving torque Trv is composite torque consisting of intake valve driving torque needed by the intake camshaft 12R to drive the intake valves 11 of the two outer cylinders of the right cylinder bank 2R and exhaust valve driving torque needed by the exhaust camshaft 22R to drive the exhaust valves 21 of the two outer cylinders of the right cylinder bank 2R when the two inner cylinders of the right cylinder bank 2R are deactivated. The right cylinder bank driving torque Tr is sum of the valve driving torque Trv and the pump driving torque Trp.

The valve driving torque Trv varies in a negative zone and decreases from 0 to a minimum of about −11 N·m in the crank angle range of 0° to 90°, varies in a positive zone and reaches a maximum of about 12.5 N·m in the crank angle range of 90° to 180°, varies from positive values to negative values, from negative values to positive values and from positive values to negative values again in the crank angle range of 180° to 540°, varies from positive values to negative values and from negative values to positive values in the crank angle range of 540° to 630°, and increases to a maximum of about 12.5 N·m and then decreases to 0 in the crank angle range of 630° to 720°.

The pump driving torque Trp varies in a positive zone and increases from 0 to a maximum of about 11 N·m in the crank angle range of 0° to 90°, varies in a negative zone and reaches a minimum toque of about −4 N·m in the crank angle range of 90° to 180°, remains 0 N·m in the crank angle range of 180° to 540° in which the pump drive cam 12Rp does not drive the fuel injection pump 70R, varies in the positive range and reaches a maximum of about 11 N·m in the crank angle range of 540° to 630°, and varies in the negative range, reaching a minimum of about −4 N·m and then increasing to 0 N·m in the crank angle range of 630° to 720°.

At phases corresponding to those in the crank angle ranges of 90° to 180° and 630° to 720° at which the valve driving torque Trv varies in the positive zone, the pump driving torque Trp varies in the negative zone while the V-8 internal combustion engine E1 is partially deactivated. At phases corresponding to those in the crank angle ranges of 0° to 90° and 540° to 630° in which the valve driving torque Trv varies in the negative zone, the pump driving torque Trp varies in the positive zone while the V-8 internal combustion engine E1 is partially deactivated. Thus, the valve driving torque Trv and the pump driving torque Trp increase and decrease in opposite directions, respectively.

The phase of the pump drive cam 12Rp is determined such that the phase at which the valve driving torque Trv reaches a maximum of about 12.5 N·m coincides substantially with the phase at which the pump driving torque Trp reaches a minimum of about −11 N·m, and the phase at which the valve driving torque Trv reaches a minimum of about −11 N·m coincides substantially with the phase at which the pump driving torque Trp reaches a maximum of about 11 N·m.

Thus, the valve driving torque Trv and the pump driving torque Trp vary in opposite directions, respectively, so as to cancel each other. The maximum of the right cylinder bank driving torque Tr consisting of the valve driving torque Trv and the pump driving torque Trp is limited to the lowest possible value as shown in FIG. 8.

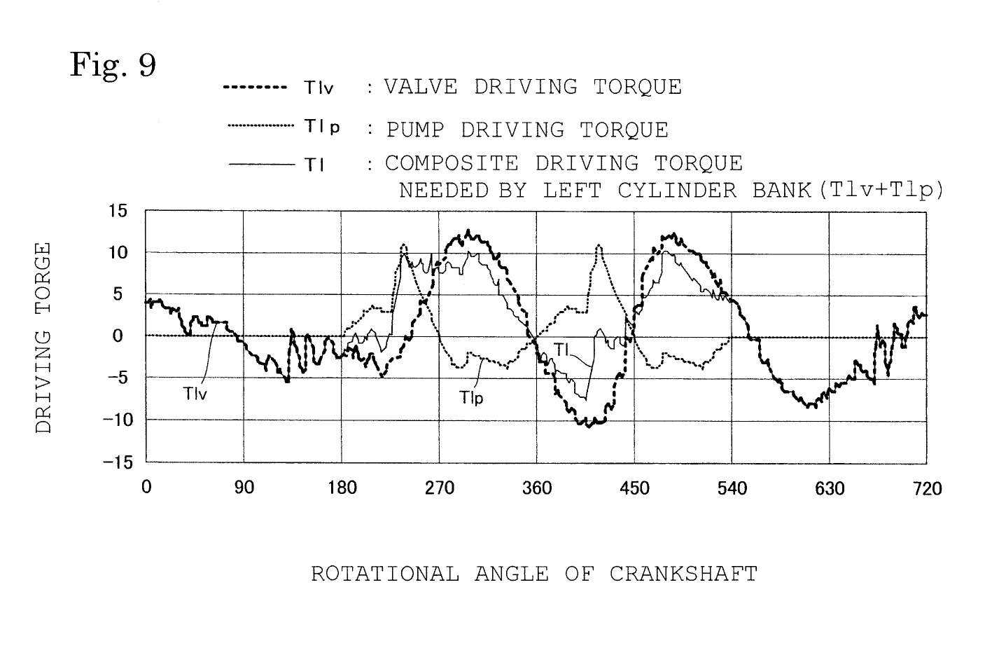

FIG. 9 is a diagram showing the variation of torques respectively needed by the intake camshaft 12L and the exhaust camshaft 22L for the left cylinder bank 2L with crank angle while the V-8 internal combustion engine E1 is in a partially deactivated state. There is a phase difference of 360° between the phase of the variation of the valve driving torque Tlv indicated by a thick broken curve for the left cylinder bank 2L shown in FIG. 9 and the phase of the variation of the valve driving torque Trv for the right cylinder bank 2R shown in FIG. 8 and between the phase of the variation of the pump driving torque Tlp indicated by a dotted curve for the left cylinder bank 2L shown in FIG. 9 and the phase of the variation of the pump driving torque Trp for the right cylinder bank 2R shown in FIG. 8.

Thus, as obvious from FIGS. 8 and 9, there is a phase difference of 360° between the right cylinder bank driving torque Tr and the left cylinder bank driving torque Tl, which is indicated by a continuous curve and consisting of the valve driving torque Tlv and the pump driving torque Tlp. The maximum of the left cylinder bank driving torque Tl is limited to the lowest possible value as shown in FIG. 9.

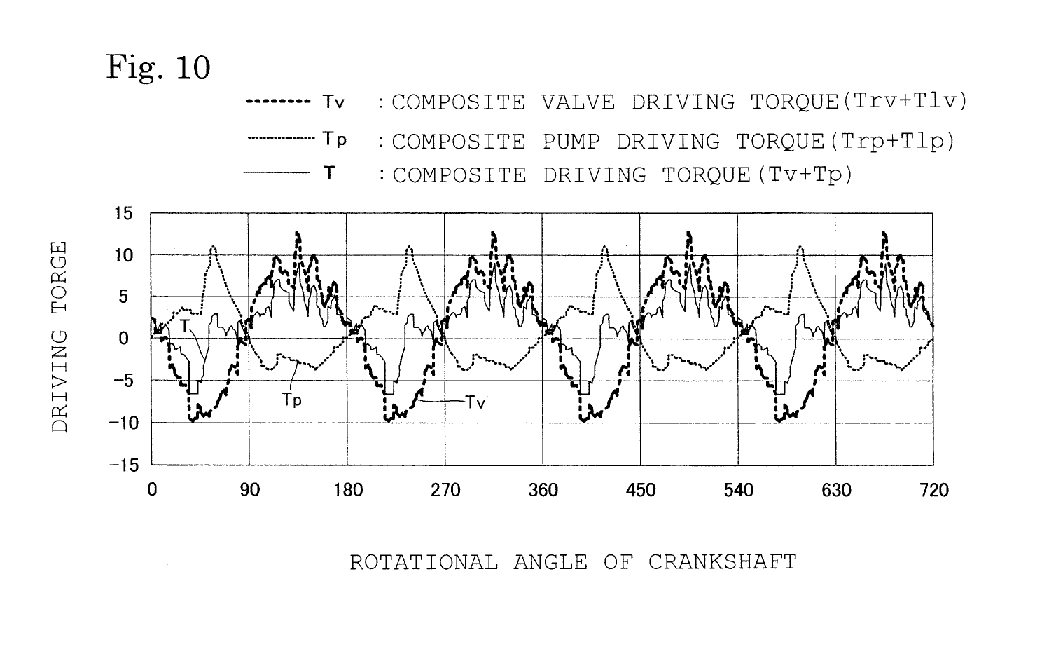

FIG. 10 is a diagram showing the variation of a composite torque consisting of torques needed by the respective intake and exhaust camshafts of the right and left cylinder banks with crank angle when the V-8 internal combustion engine E1 is in a partially deactivated state. Composite valve driving torque Tv consisting of the valve driving torques Trv and Tlv needed by the right cylinder bank 2R and the left cylinder bank 2L is indicated by thick broken curve, a composite pump driving torque Tp consisting of the pump driving torques Trp and Tlp needed by the right cylinder bank 2R and the left cylinder bank 2L is indicated by a dotted curve, and composite torque T consisting of the cylinder bank driving torques Tr and Tl is indicated by a continuous curve.

The composite torque T consisting of the cylinder bank driving torques Tr and Tl corresponds to the driving torque of the crankshaft 1 for driving the intake camshafts 12R and 12L and the exhaust camshafts 22R and 22L through the timing belt 37.

As shown in FIG. 10, the composite pump driving torque Tp varies in the negative zone at phases corresponding to crank angles in the ranges of 90° to 180°, 270° to 360°, 450° to 540° and 630° to 720° in which the composite valve driving torque Tv varies in the positive range, and the composite pump driving torque Tp varies in the positive zone at phases corresponding to crank angles in the ranges of 0° to 90°, 180° to 270°, 360° to 450° and 540° to 630° in which the composite valve driving torque Tv varies in the negative zone. Thus, the composite valve driving torque Tv and the composite pump driving torque Tp vary in opposite directions, respectively.

The phase at which the composite valve driving torque Tv reaches a maximum of about 12.5 N·m coincides substantially with the phase at which the composite pump driving torque Tp reaches a minimum of about −4 N·m, and the phase at which the composite valve driving torque Tv reaches a minimum of about −11 N·m coincides substantially with the phase at which the composite pump driving torque Tp reaches a maximum of about 11 N·m.

Thus, the composite valve driving torque Tv and the composite pump driving torque Tp vary so as to cancel each other. Consequently, the maximum of total driving torque T consisting of the composite valve driving torque Tv and the composite pump driving torque Tp is limited to the lowest possible value, as shown in continuous curve in FIG. 10.

The pump driving torques Trp and Tlp needed to drive the fuel injection pumps 70r and 70l for supplying high-pressure fuel to the fuel injection valves 30 required to inject fuel at a high injection pressure are comparatively high. Therefore, maximum of the composite torque T consisting of the valve driving torques Trv and Tlv and the pump driving torques Trp and Tlp can be effectively reduced and the variation of the composite driving torque T can be suppressed to the least extent.

The maximum of the composite driving torque consisting of the valve driving torque and the pump driving torque when two fuel injection pumps each requiring a low or reduced pump driving torque are included in the two cylinder banks, respectively, is lower than that when one fuel injection pump requiring a high pump driving torque is included in one of the two cylinder banks. When two fuel injection pumps requiring a low pump driving torque are included in the two cylinder banks, respectively, the variation of the composite driving torque can be effectively suppressed and the load on the timing belt 37 can be reduced.

In the V-8 internal combustion engine E1 in the first embodiment, the fuel injection pumps 70R and 70L are driven by the intake camshafts 12R and 12L for the two cylinder banks 2R and 2L, respectively. In a modification, the fuel injection pumps 70R and 70L may be driven by the exhaust camshafts 22R and 22L, respectively.

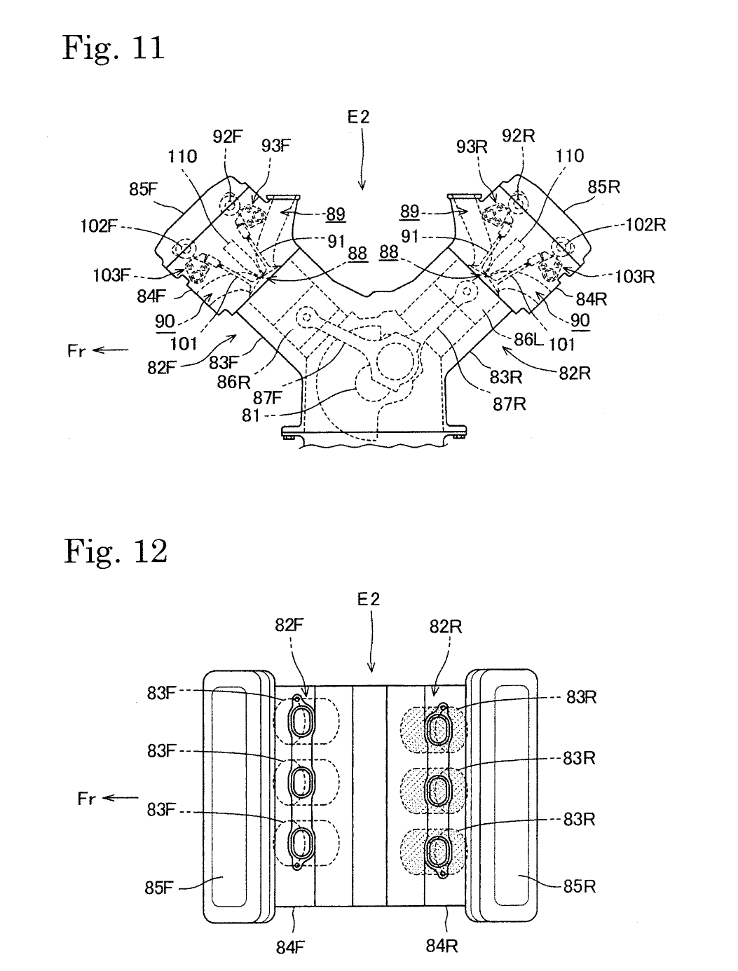

A partially deactivatable internal combustion engine E1 (hereinafter, referred to as “V-6 internal combustion engine E2”) in a second embodiment of the invention will be described with reference to FIGS. 11 to 14.

As shown in FIG. 11, the V-6 internal combustion engine E2 is a water-cooled four-stroke V-6 automotive internal combustion engine. The V-6 internal combustion engine E2 is mounted on a vehicle with its crankshaft 81 extending in a lateral direction perpendicular to the longitudinal axis of the body of the vehicle. The V-6 internal combustion engine E2 has a front cylinder bank 82F and a rear cylinder bank 82R set at an angle to form a V. In FIG. 11, “Fr” indicates the front side of the vehicle.

Referring to FIG. 12, the front cylinder bank 82F and the rear cylinder bank 82R have three cylinders 83F and three cylinders 83R, respectively. The front cylinder bank 82F is displaced slightly rightward relative to the rear cylinder bank 82R.

As shown in FIG. 11, cylinder heads 84F and 84R are put on and fastened to the front cylinders 83F and the rear cylinders 83R, respectively. The cylinder heads 84F and 84R are covered with head covers 85F and 85R. The front cylinder bank 82F including the cylinders 83F, the cylinder head 84F and the head cover 85F, and the rear cylinder bank 83R including the cylinders 83R, the cylinder head 84R and the head cover 85R are set at an angle to form a V.

Pistons 86F and 86R are axially slidably fitted in the cylinder bores of the cylinders 83F and 83R, respectively. The pistons 86F and 86R are connected to the crankshaft 81 by connecting rods 87F and 87R, respectively, to form a piston-crank mechanism. Combustion chambers 88 are formed by the top surfaces of the pistons 86F and 86R and the cylinder heads 84F and 84R, respectively. Intake ports 89 opening into the combustion chambers 88 extend inward, i.e., toward the space between the front cylinder bank 82F and the rear cylinder bank 82R, on the inner side of the front cylinder bank 82F and the rear cylinder bank 82R. Exhaust ports 90 extend outward, i.e., away from the space between the front cylinder bank 82F and the rear cylinder bank 82R, on the outer side of the front cylinder bank 82F and the rear cylinder bank 82R.

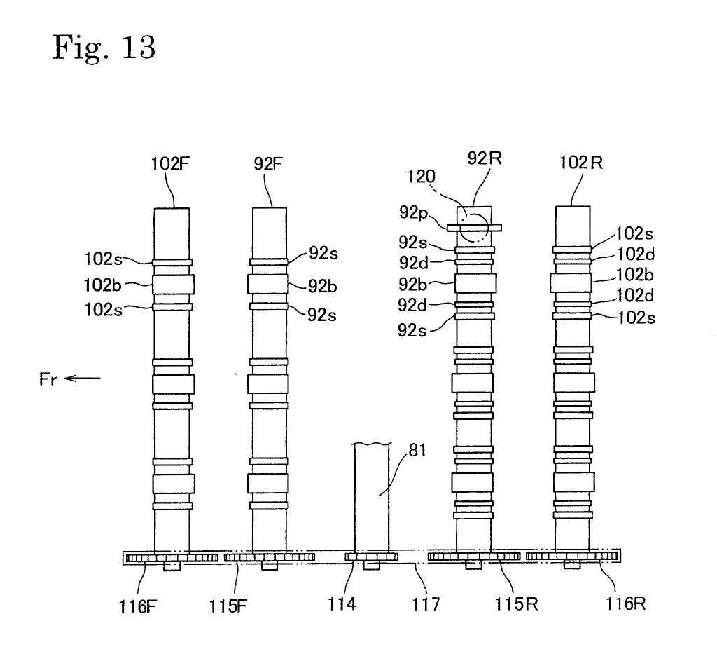

An intake camshaft 92F and an exhaust camshaft 102F, namely, valve drive camshafts, extend parallel to the crankshaft 81 on the cylinder head 84F, and an intake camshaft 92R and an exhaust camshaft 102R, namely, valve drive camshafts, extend parallel to the crankshaft 81 on the cylinder head 84R to form DOHC valve trains, respectively. As shown in FIG. 13, the intake camshafts 92F and 92R are on the inner sides of the cylinder banks 82F and 82R, respectively. The exhaust camshafts 102F and 102R are on the outer sides of the cylinder banks 82F and 82R, respectively.

Intake valves 91 for opening and closing intake port 89 opening into the combustion chamber 88 and the intake camshaft 92F (92R) are interlocked by an intake valve drive mechanism 93F (93R) for converting rotation of the intake camshaft 92F (92R) into axial motion of the intake valves 91.

Exhaust valves 101 for opening and closing exhaust ports 90 opening into the combustion chamber 88 and the exhaust camshaft 102F (102R) are interlocked by an exhaust valve drive mechanism 103F (103R) for converting rotation of the exhaust camshaft 102F (102R) into axial motion of the exhaust valves 101.

The intake valve drive mechanisms 93F and 93R and the exhaust valve drive mechanisms 103F and 103R are provided with a valve lift changing mechanism for changing valve lift according to operating conditions of the V-6 internal combustion engine E2. Some of the intake valve drive mechanisms 93F and 93R and some of the exhaust valve drive mechanisms 103F and 103R are provided with a deactivating mechanisms for keeping the intake valves 91 and the exhaust valves 101 closed to deactivate the corresponding cylinders 83F (83R), and other intake valve drive mechanisms 93F and 93R and other exhaust valve drive mechanisms 93F and 93R are not provided with any deactivating mechanism.

The cylinders each provided with the deactivating intake valve drive mechanism and the deactivating exhaust valve drive mechanism are deactivatable cylinders. The cylinders each provided with the continuously working intake valve drive mechanism and the continuously working exhaust valve drive mechanism are continuously working cylinders.

As shown in FIG. 12, in the V-6 internal combustion engine E2, the three cylinders of the front cylinder bank 82F are continuously working cylinders and the three cylinders of the rear cylinder bank 82R are deactivatable cylinders. In FIG. 12, the deactivatable cylinders are shaded with crossing oblique broken lines.

The intake valve drive mechanism 93F and the exhaust valve drive mechanism 103F for the three cylinders of the front cylinder bank 82F is not provided with a deactivating mechanism and is the same in construction as the continuously working intake valve driving mechanism of the first embodiment shown in FIG. 6. The intake valve drive mechanisms 93R and the exhaust valve drive mechanisms 103R of the three cylinders of the rear cylinder bank 82R is provided with the deactivating mechanism and is the same in construction as the deactivating intake valve drive mechanism of the first embodiment shown in FIG. 7.

The V-6 internal combustion engine E2 is provided with fuel injection valves 110 for injecting fuel directly into the combustion chambers 88. The fuel injection valves 110 are inserted into bores formed in parts of the cylinder heads 84F and 84R corresponding to the centers of the tops of the combustion chambers 88 and opening into the combustion chambers 88, respectively.

Spark plugs, not shown, are inserted into bores formed in the cylinder heads 94F and 84R so as to face the combustion chambers 88, respectively.

FIG. 13 shows the arrangement of the intake camshafts 92F and 92R and the exhaust camshafts 102F and 102R of the valve trains. As shown, driven pulleys 115F and 115R are mounted on the left ends of the intake camshaft 92F and 92R, respectively, and driven pulleys 116F and 116R are mounted on the left ends of the exhaust camshafts 102F and 102R, respectively.

An endless timing belt 117 is wound round a drive pulley 114 mounted on the crankshaft 81 and the driven pulleys 115F, 115R, 1126F and 116R to transmit the rotation of the crankshaft 81 to the intake camshafts 92F and 92R and the exhaust camshafts 102F and 102R.

The intake camshafts 92F and 92R and the exhaust camshafts 102F and 102R rotate at half the rotational speed of the crankshaft 81.

Referring to FIG. 13, the three cylinders of the front cylinder bank 82F are continuously working cylinders. Parts of the intake camshaft 92F corresponding to the cylinders of the front cylinder bank 82F are provided at their middle parts with high-lobe intake cams 92b, respectively. Parts of the exhaust camshaft 102F corresponding to the cylinders of the front cylinder bank 82F are provided at their middle parts with high-lobe exhaust cams 102b, respectively. Low-lobe intake cams 92s are formed adjacent to each of the high-lobe intake cams 92b on both sides of the same, respectively. Low-lobe exhaust cams 102s are formed adjacent to each of the high-lobe exhaust cams 102b on both sides of the same, respectively.

The three cylinders of the rear cylinder bank 82R are deactivatable cylinders. Parts of the intake camshaft 92R corresponding to the cylinders of the rear cylinder bank 82R are provided at their middle parts with high-lobe intake cams 92b, respectively. Round deactivating cams 92b not having any cam lobe are formed adjacent to each of the high-lobe intake cams 92b on both sides of the same, respectively. Parts of the exhaust camshaft 102R corresponding to the cylinders of the rear cylinder bank 82R are provided at their middle parts with high-lobe exhaust cams 102b, respectively. Round deactivating cams 102b not having any cam lobe are formed adjacent to each of the high-lobe exhaust cams 102 on both sides of the same, respectively. A low-lobe intake cam 92s and a low-lobe exhaust cam 102s are formed adjacent to each of the deactivating cams 92d and each of the deactivating cams 102d on the outer side of each deactivating cams 92d and 102d, respectively.

A pump drive cam 92p is formed adjacent to the right end of the intake camshaft 92R for the rear cylinder bank 82R provided with the deactivatable cylinders. A fuel injection pump 120 is disposed above the pump drive cam 92p with an actuator extending downward from the fuel injection pump 120 in contact with the cam surface of the pump drive cam 92p. The pump drive cam 92p drives the actuator.

The pump drive cam 92p is a substantially triangular cam having three cam toes. Since the intake camshaft 92R makes one full turn while the crankshaft 81 makes two full turns, the pump drive cam 92p reciprocates the actuator of the fuel injection pump 120 three times while the intake camshaft 92R makes one full turn.

The fuel injection pressure of the fuel injection pump 120, similarly to those of the fuel injection pumps 70R and 70L of the first embodiment, is controlled in a fuel spill control mode. The fuel injection pump 120 supplies fuel to fuel injection valves 110 for the cylinders of the front cylinder bank 82F and the rear cylinder bank 82R.

When the V-6 internal combustion engine E2 operates in a partially deactivated mode, all the three cylinders of the front cylinder bank 82F work and all the three cylinders of the rear cylinder bank 82R are deactivated.

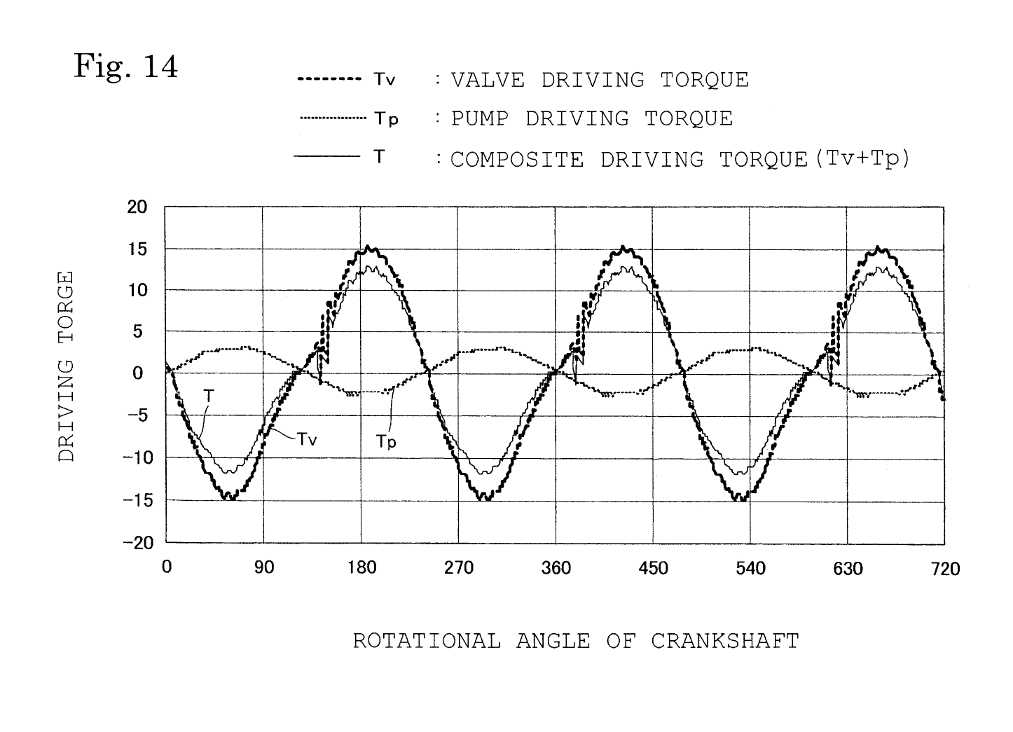

FIG. 14 shows, by a thick broken curve, the variation of composite valve driving torque Tv consisting of intake valve driving torque and exhaust valve driving torque needed by the intake camshaft 92F and the exhaust camshaft 102F of the front cylinder bank 82F. FIG. 14 also shows, by a dotted curve, the variation of pump driving torque Tp needed by the pump drive cam 92p for driving the fuel injection pump 120 of the intake camshaft 92R of the rear cylinder bank 82R and shows, by a continuous curve, the variation of composite driving torque T consisting of the valve driving torque Tv and the pump driving torque Tp.

The composite driving torque T consisting of all the camshaft driving torques corresponds to the driving torque of the crankshaft 81 for driving the camshafts through the timing belt 117.

As shown in FIG. 14, while the V-6 internal combustion engine E2 is operating in the partially deactivated mode, the pump driving torque Tp varies in the negative zone at phases at which the valve driving torque Tv varies in the positive zone, and the pump driving torque Tp varies in the positive zone at phases at which the valve driving torque Tv varies in the negative zone. Thus, the pump driving torque Tp and the valve driving torque Tv vary in opposite directions, respectively.

A crank angle at which the valve driving toque Tv reaches a maximum of about 15 N·m and a crank angle at which the pump driving torque Tp reaches a minimum of about −15 N·m coincide substantially with each other. A crank angle at which the valve driving toque Tv reaches a minimum of about −15 N·m and a crank angle at which the pump driving torque Tp reaches a maximum of about 2.5 N·m coincide substantially with each other.

Thus, the valve driving torque Tv needed to drive the valve train for the continuously working front cylinders 82F and the pump driving torque Tp needed by the valve train for the deactivatable rear cylinders 82R vary so as to cancel each other effectively. Consequently, the maximum of the composite driving torque T consisting of the valve driving torque Tv and the pump driving torque Tp is limited to the lowest possible value as indicated by the continuous curve in FIG. 14.

The pump driving torque Tp needed to drive the fuel injection pump 120, which is required to supply fuel under high pressure to the direct-injection fuel injection valves 110 required to achieve high-pressure fuel injection, is comparatively high. The maximum of the composite torque T consisting of the valve driving torque Tv and the pump driving torque Tp can be effectively reduced and load on the timing belt 117 can be reduced by suppressing the variation of the composite driving torque T.

In the V-6 internal combustion engine E2 in the second embodiment, the pump drive cam 92p for driving the fuel injection pump 120 is formed on the intake camshaft 92R for the rear cylinder bank 84R provided with the deactivatable cylinders 83R. The pump drive cam 92p may be formed on the exhaust camshaft 102R for the rear cylinder bank 84R and the fuel injection pump 120 may be disposed so as to be driven by the pump drive cam 92p.

Although the pump drive cam for driving the fuel injection pump is formed on the camshaft in the first and second embodiments, the camshaft may be used for driving other accessory, such as a water pump, and the camshaft may be provided with a gear for driving an accessory.

When the respective phases of the valve drive cams for driving the intake and exhaust valves are not equally distributed, in some cases, it is difficult to so determine the phase of the pump drive cam that the phase at which the valve driving torque needed by the valve drive cams reaches a maximum (or a minimum) coincides with the phase at which the pump driving torque needed by the pump drive cam reach a minimum (or a maximum)

In such a case, it is preferable to determine the phase of the pump drive cam such that the phase at which the valve driving torque needed by the valve drive cams reaches a maximum (or a minimum) does not coincide with the phase at which the pump driving torque needed by the torque drive cam reaches a maximum (or a minimum).

In that case, it is preferable that the phase at which the valve driving torque needed by the valve drive cams reaches a maximum (or a minimum) does not coincide with the phase at which the pump driving torque needed by the pump drive cam reaches a maximum (or a minimum)

Generally, the absolute value of the positive torque is greater than that of the negative torque. Therefore, it is desirable to determine the phase of the pump drive cam preferentially such that the phase at which the pump driving torque needed by the pump drive cam does not coincide with the phase at which the valve driving torque needed by the valve drive cams reaches a maximum.

What is claimed is:

1. A partially deactivatable internal combustion engine comprising:
two cylinder banks each having cylinders;
engine valves provided for each of the cylinders;
camshafts provided in each of the cylinder banks to open and close the engine valves for the cylinders;
the cylinders including continuously working cylinders and deactivatable cylinders which are deactivated by keeping the engine valves therefor closed; and
an engine accessory;
wherein the engine accessory is configured to be driven for operation by a camshaft in a cylinder bank having a deactivatable cylinder.

2. The partially deactivatable internal combustion engine according to claim 1, wherein both the cylinder banks have deactivatable cylinders, respectively, and the camshaft for driving the engine accessory is provided in each of the cylinder banks.

3. The partially deactivatable internal combustion engine according to claim 1, wherein all the cylinders of one of the cylinder banks are continuously working cylinders, all the cylinders of the other cylinder bank include a deactivatable cylinder, and the engine accessory is driven for operation by the camshaft of the other cylinder bank.

4. The partially deactivatable internal combustion engine according to claim 1, further comprising a fuel injection valve for directly injecting fuel into each of the cylinders;
wherein the engine accessory is a fuel injection pump, the camshaft for driving the engine accessory has a pump drive cam formed on the camshaft, and the fuel injection pump has a pump actuator driven by the pump drive cam on the camshaft to supply fuel under pressure to the fuel injection valve.

5. The partially deactivatable internal combustion engine according to claim 4, wherein, the camshafts have valve drive cams for opening and closing the engine valves, respectively, and the pump drive cam is configured to have such an operational phase relative to those of the valve drive cams for driving the engine valves that a phase at which a valve driving torque needed by the camshafts reaches a maximum or a minimum does not coincide with a phase at which a pump driving torque needed by the camshaft provided with the pump drive cam reaches a maximum or a minimum, while the partially deactivatable internal combustion engine is operating in a partially deactivated mode in which the deactivatable cylinders are deactivated.

6. The partially deactivatable internal combustion engine according to claim 5, wherein the phase of the pump drive cam relative to those of the valve drive cams for driving the engine valves is determined such that the phase at which the valve driving torque of the camshafts reaches a maximum or a minimum substantially coincides with the phase at which the pump driving torque needed by the camshaft having the pump drive cam reaches a minimum or a maximum, while the partially deactivatable internal combustion engine is operating in a partially deactivated mode in which the deactivatable cylinders are deactivated.
